(19) United States
(12) Patent Application Publication
(10) Pub. No.: US 2012/0125834 A1
(43) Pub. Date: May 24, 2012

(54) FILTER DEVICE AND FILTER ELEMENT ARRANGEMENT FOR USE IN THE FILTER DEVICE

(76) Inventors: Christian Gessner, St. Wendel (DE); Bernhard Schlichter, Saarbucken (DE)

(21) Appl. No.: 13/261,108

(22) PCT Filed: Jun. 12, 2010
(86) PCT No.: PCT/EP2010/003552

§ 371 Date: Jan. 31, 2012

(30) Foreign Application Priority Data
Jul. 2, 2009 (DE) 10 2009 031 358.3

(51) Int. Cl. B01D 29/68

(52) U.S. Cl. 210/411

(57) ABSTRACT

A filter device having a multiplicity of filter elements (2) which can be held in a filter housing (4) having a filter inlet (6) for a fluid (8) to be filtered and having a filter outlet (10) for the filtered fluid (12), wherein the filter elements (2) can be traversed by flow in both directions for filtration or back-flushing, is characterized in that, between at least a part of the filter elements (2) and the filter outlet (10), in each case one further filter element, in particular in the form of a fine filter element (14), is arranged in regions of the flow path of the fluid which is pre-filtered by the respective filter element (2) assigned to the further filter element (14).

The invention relates to a filter device having a plurality of filter elements which can be accommodated in a filter housing having a filter inlet for a fluid to be filtered and a filter outlet for the filtered fluid, flow through the filter elements being possible in both directions for filtration or backflushing. The invention furthermore relates to a filter element arrangement for use in these filter devices.

DE 199 56 859 A1 discloses a filter device with conically shaped filter elements in the form of so-called cylindrical wedge wire screen filter elements with a backflushing means. All filter elements are preferably regenerated in succession with the backflushing means. During the backflushing of individual elements, filtration is continued over the remaining elements so that filtration operation need not be interrupted at any time.

Such conical cylindrical wedge wire screen filter elements are very well suited to a backflushing of filtered out particles, and, for support of the backflushing process, the known solution proposes a pressure control means which generates a negative pressure on the filter element which is to be backflushed in order to induce cleaning in a pulsed manner. A comparable pressure control means with pulsed cleaning characteristics for a comparable filter device is also disclosed in DE 10 2007 054 737 A1.

On the basis of this prior art, the object of the invention is to provide a filter device of the indicated type which enables improved cleaning results and deposition rates in the actual filtration operation in a regeneration, which can be easily carried out, for the individual filter elements. This object is achieved by a filter device having the features of claim 1 in its entirety and a filter element arrangement having the features of claim 19.

According to the characterizing part of claim 1, the particularity of the solution according to the invention resides in the fact that between at least some of the filter elements and the filter outlet, in each instance one further filter element, especially in the form of a fine filter element, is arranged in the regions of the flow path of the fluid which is prefiltered by the respective filter element assigned to the further filter element. Due to the interaction of the filter element with the fine filter element, the stipulated filter fineness can be greatly increased by the fine filter elements connected downstream of the upstream filter elements in the filtration chain. Thus, for example, the filter element can have a filter fineness of 50 μm to 100 μm within the context of prefiltration, and the further or fine filter element then has a filter fineness from 5 to 10 μm in order to retrieve even extremely fine particulate dirt from the prefiltrate.

Since in one especially preferred embodiment, the filter elements are formed from so-called cylindrical wedge wire screen filter elements which are of low sensitivity both in the filtration direction and also in the backflushing direction of the fluid to differential pressures which can also occur intermittently or pulsed, due to their material structure, the fine filter elements can, however, already prove to be very pressure-sensitive, and are not backflushed in the backflushing or regeneration of the prefilter elements and in this respect are protected. With the filter device according to the invention, it is therefore possible for the first time to combine a coarse with a fine filtration via separate filter element arrangements and still achieve cleaning or regeneration in the backflushing mode for the prefiltration stage.

The aforementioned object is also achieved according to the invention by a filter element arrangement provided for use in the filter device according to the invention, in which the respective filter element with the further filter element, preferably in the form of a fine filter element, constitutes a manageable, replaceable unit. Irrespective of this, it can, however, also be provided that the durably made filter elements of the prefiltration stage be left in the filter housing and only the fine filter element then be replaced by a new fine filter element at a corresponding degree of fouling.

The fine filter elements are preferably made tubular and placed over the filter elements of the prefiltration stage such that they are completely surrounded or encompassed radially with a definable distance. The fine filter elements are thus used to separate particles which are not captured by the filter elements, designed preferably as cylindrical wedge wire screen filter elements. The filter housing has a much greater axial extension than that of the filter elements, wherein the fine filter elements in turn extend over the entire overall height or length of the filter housing in the latter and thus can have a significantly increased effective filter area compared to the filter elements.

In normal filtration operation, flow takes place from the inside to the outside through both the filter elements and also the further filter elements, especially in the form of fine filter elements, and the fluid which has been filtered in this way travels to the filtrate side or clean side of the filter housing for the subsequent discharge via the filter outlet of the housing. At the same time, however, a partial amount of the fluid which has been prefiltered by the filter elements is routed along the inside of the respective fine filter element of a filter element arrangement in order to expose to incident flow with the prefiltrate a filter element which is to be backflushed or regenerated by means of a central cover guide in the upper housing part, such that feed takes place essentially exclusively via the interior of the fine filter element which is made hollow-cylindrical, which remains excluded from backflushing, and which is protected in this respect on account of the sensitive filter material. For conventional filtration, the further fine filter elements remain in the regions of the fluid flow path provided for this purpose.

The fine filter elements are preferably made tubular and can be continuously wound in the manner of a depth filter from webs of paper, textiles, or plastics so that a kind of wound filter or a wound belt filter is formed. Instead of this wound cartridge, foamed plastic elements or pleated filter elements can be also used, and the respective element material can be supported on corresponding support grates or support layers to obtain a compression-resistant construction. If the fine filter elements have a pleated surface shape, their effective filter surface is increased.

It is especially advantageous to change the pore size of the filter material over the depth of the fine filter elements and, especially on the side facing the fluid which is to be filtered, to choose a larger pore size or mesh width than on the clean side which faces away; this can also take place via a compression of the wound material combination to the outside.

Preferably, the filter elements and the fine filter elements are located at distances to one another along an arc within the filter housing. However, it can also be advantageous to arrange the filter element arrangement, consisting in each instance of one filter element and one fine filter element, repeatedly divided into groups along cylindrical arcs which run in such a manner in concentrically arranged circles to one another to the longitudinal axis of the filter housing.

Preferably, one filter element and one fine filter element each are combined in a filter element arrangement and, along a vertical longitudinal axis which runs parallel to the longitudinal axis of the filter housing, are held in the latter. The filter housing likewise has a cylindrical shape, and both a cover and a bottom made as flat plates can be screwed to the remaining filter housing, which is formed from a cylindrical pipe so that the arrangement is also suited for high fluid pressures.

Preferably, it is furthermore provided that the cover contains a device for securing the fine filter elements within the housing. The fine filter elements in particular require a pressure pad which acts in the axial direction and which prevents the fine filter elements from detaching from their seat in the region of the bottom part of the filter housing. The device for securing the fine filter element or the holding means has in particular a disk made preferably circular with openings roughly in the size range of the diameter of the outside diameter of the fine filter elements or smaller. The individual openings are spaced apart from one another over wall parts of the disk, and these wall parts come into contact with the axial ends of the fine filter elements. If the remaining openings overlap the fluid-carrying middle space of the respective fine filter element, the feed of prefiltered fluid to the filter element which is to be backflushed is possible for the indicated backflushing process. Here a partial flow of prefiltered fluid, which is routed past the filtering fine filter element in the middle of its cavity in the bypass and therefore is supplied from all filtering arrangements, is made available to the respective arrangement which is to be backflushed.

The disk-shaped holding means can be secured by way of a retaining arm with a corresponding quarter-turn fastener within the filter housing, and the fine filter elements are thus held via the disk in their installation position in the filter housing. Due to the quarter-turn fastener, if necessary, a prompt replacement of the fine filter elements in the clogged, used state by a new element is possible, as is the replacement of an entire element arrangement consisting of filter element and fine filter element.

In one especially preferred embodiment of the filter device according to the invention, it is provided that a backflushing means with at least one backflushing arm be moved from the bottom side of the filter housing to under the respectively assigned filter element, which backflushing arm discharges the amount of reverse filtrate forming during backflushing from the filter device. To actuate the respective backflushing arm, a motor-gear arrangement is used which is located especially preferably on the bottom of the filter device so that a short drive segment is implemented; this accommodates smooth, dedicated operation of the backflushing arm.

The invention is detailed below using one exemplary embodiment shown in the drawings. The figures are schematic and not to scale.

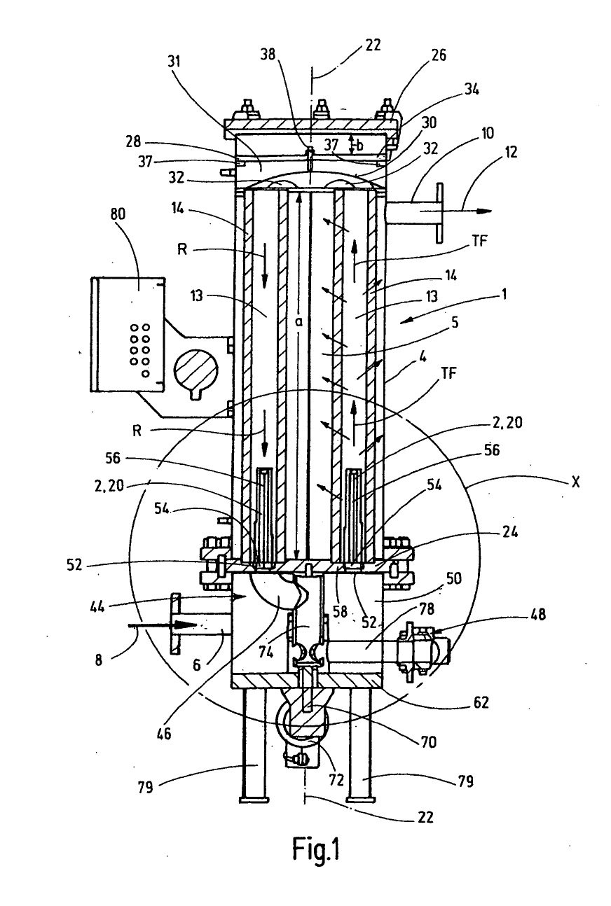

FIG. 1 shows the filter device as a whole partially in a front view, partially in a longitudinal section;

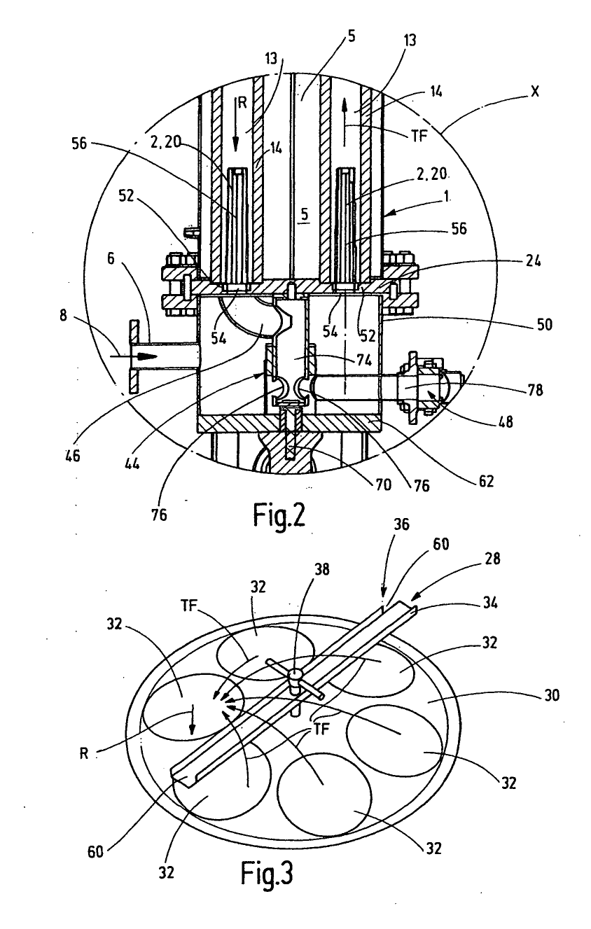

FIG. 2 shows the article of the extract designated as “X” in FIG. 1, enlarged; and

FIG. 3 shows a perspective view of a holding means for fine filter elements as shown in FIGS. 1 and 2.

FIG. 1 shows a filter device 1 with a cylindrical filter housing 4 partially in a front view, partially in a longitudinal section. The filter housing 4, viewed in the direction of looking at FIG. 1, is terminated downwardly by a bottom 24 and upwardly by a cover 26. The cover 26 and the bottom 24 are screwed to the cylindrical filter housing 4 via flange connections in the conventional manner and are therefore not shown. Under the bottom 24, there is an intermediate housing 50 which is provided with a filter inlet 6 made as a pipe socket for the feed of unfiltered material. Therefore, fluid 8 to be filtered is supplied through the filter inlet 6 from the underside of the filter device 1. Fluid 12 filtered by the device is discharged underneath the cover 26 through the filter outlet 10 for miscellaneous re-use, for example, into a conventional hydraulic circuit.

The bottom 24 contains individual receivers 52 spaced apart from one another for filter elements 2 which are shaped in the illustrated exemplary embodiment as conical, cylindrical wedge wire screen filter elements 20 which taper upward from their respective inlet opening 54 in the region of the bottom 24. These metallic cylindrical wedge wire screen filter elements 20 are ideal for this application due to their pressure stability. In this case, the fluid medium to be filtered flows through the respective slit tube 20 from the inside to the outside so that solid contamination such as particles can settle on the inside of the filter elements 2. As fouling increases, the differential pressure then rises between the dirty side and clean side of this filter element 2, and when the pressure loss reaches the set triggering differential pressure, automatic backflushing begins in which particles are detached from the gaps of the filter element 2 from the outside to the inside and are discharged from the filter device 1 via the inside of the element 2. If the cylindrical wedge wire screen filter element 20 consists of high-grade steel components, treatment of corrosive media with the filter device according to the invention is also possible.

The filter elements 2 are arranged at radial distances from one another along a closed arc or circle within the filter housing 4. In an embodiment which is not detailed, there can also be the filter elements 2 divided into groups along several circles which are arranged concentrically to the longitudinal axis 22 of the filter housing 4.

As FIG. 2 in particular shows, the filter elements 2 with their lower free inlet cross section, that is, via their inlet opening 54, discharge into the cylindrically shaped receivers 52 in the bottom 24 of the filter device and, to carry fluid, are connected to the intermediate housing 50 which accommodates the quantity of unfiltered material, unless, as shown in FIG. 2, the backflushing means 44, which is still to be detailed, with its backflushing arm 46 is moved for a backflushing process under the inlet opening 54 of an element 2 which is to be backflushed. If the normal filtration process in the regions of the flow path of the fluid is examined, the fluid 8 which is to be filtered travels via the interior of the intermediate housing 50 into the inner filter cavity 56 of the respective filter element 2, and flow for the filtration takes place through the filter elements 2 from the inside to the outside. In this way, the filter elements 2 perform a type of prefiltration, and the fluid 12 which has been prefiltered in this way flows partially as a partial fluid amount TF along a major axis direction parallel to the longitudinal axis 22 of the filter housing 4 viewed in the direction of looking at the figures from the bottom to the top through the cylindrical cavity 13 of a fine filter element 14. Flow through the latter likewise takes place from the inside to the outside so that, within the filter housing 4, the filtrate space 5 is formed via which prefiltered and fine-filtered fluid then leaves the device via the filter outlet 10.

The fine filter elements 14 in the illustrated exemplary embodiment are made as cylindrical fine filter cartridges, for example, consisting of a filter mat, and they can be conventionally stiffened with a cylindrical support means, which is not detailed, to such an extent that they extend without further radial guidance parallel to the longitudinal axis 22 of the cylindrical wedge wire screen filter elements 20 over the entire essential installation length a of the cylindrical filter housing 4. On the bottom 24, the respective fine filter elements 14 are held in turn to be radially immovable in a receiver 58 which is located concentrically around the receiver 52 for the filter elements 2.

Toward the top, the fine filter elements 14 are secured by a holding means 28 which is located with a distance b to the cover 26 and which assumes the shape of a disk 30 which is detailed in FIG. 3. The disk 30, as shown in FIG. 1, is made as a flat and round contact part which is convex to the cover 26, which runs level, preferably as a metallic shaped part. The disk 30 has, assigned to each free filter element 14, a total of six openings 32, which are shown as round openings in this exemplary embodiment. The openings 32 have a slightly smaller diameter than the outside diameter of the fine filter elements 14 so that they are held better via the disk 30 on its underside.

The indicated openings 32 need not, however, overlap the free face end of the respective fine filter element 14 in the middle, but can have an offset such that at least the adjacent wall parts to the openings 32 form a contact surface for the face free end of the filter material of the fine filter element 14. In this respect, the number of openings 32 in an embodiment (not detailed) can also deviate from the number of fine filter elements 14. Thus, in one preferred embodiment it can be provided that only three openings 32 are used for fluid supply of six fine filter elements 14.

For the installation of a disk 30 in the housing 4 of the filter device 1, a retaining arm 34 is used which is designed as a U-section for purposes of locking with the underside of two retaining projections 37 located diametrically opposite one another relative to the longitudinal axis 22 of the housing 4, which are secured on the inside of the filter housing 4, for example, by way of a weld. If the U-shaped retaining arm 34 in its respective opposite end region has a recess 60 which are [sic] kept free from the wall parts of the U-shape of the retaining arm 34, they allow radial pivoting downward to underneath the indicated retaining projections 37 for the securing or locking process. Furthermore, in the middle between the disk 30 and the retaining arm 34, there is a tightening screw 38 which, as part of a quarter-turn fastener 36, enables an axial positioning of the disk 30 relative to the retaining arm 34 which is secured in the filter housing 4. In particular, by adjusting the tightening screw 38, the disk 30 of the holding means 28 on the top of the fine filter elements 14 can be secured with a defined clamping force.

As a collective examination of all figures shows, especially including FIG. 3, it is not the entire amount of prefiltrate which is routed from the inside to the outside through the fine filter element 14 which is in filter operation at the time, but always only a partial amount of fluid TF which flows, viewed in the direction of the arrow, from the bottom to the top through the cylindrical cavity 13 of the fine filter element 14 to be examined at the time. These partial fluid amounts TF from five filter elements 2 are brought together via the openings 32 in the disk 30 into a collecting space 31 between the top of the disk 30 and the bottom of the cover 26 and, in this way, with the formation of a common backflushing amount R, are supplied to that fine filter element 14, and specifically via its center cavity 13, in which the filter element 2 which is now to be backflushed is located in the form of a cylindrical wedge wire screen filter element 20. The prerequisite for this is that the backflushing means 44 for this element 2 is located in its effective backflushing position. Even if roughly 90% of the amount prefiltered via the filter element 2 is supplied to the fine filter element 14 for a further filtration process from the inside to the outside in the direction of the filter outlet 10 and therefore only 10% as a partial fluid amount TF remains in the interior 13 of the fine filter element 14 for the subsequent backflushing, FIG. 3 shows that then a total backflushing filter amount of roughly 50% of the total fluid flow for backflushing, delivered by five fine filter elements 14—a more than considerable value—results overall for the element 2 which is to be backflushed. This value is only exemplary and can be changed by adjusting the flow values, for example, depending on the flow values of the prefilter and fine filter elements 2, 14 used.

The already addressed backflushing means 44 of the filter device 1 in the conventional manner has a backflushing arm 46 which, guided in a slide bearing arrangement, is rotationally guided between the bottom 24 of the housing and another bottom 62 of the intermediate housing 50. For its pivoting motion, the backflushing arm 46 is connected via a gear pin connection 70 (see FIG. 2) to a geared motor 72, which is oriented perpendicular to the pin connection 70 with its driven axle, which is not detailed. The backflushing arm 46 is furthermore made arc-shaped and with its one free side always discharges underneath the free opening cross section (inlet opening 54) of the respective fine filter element 2 which is to be backflushed. With its other free end, the backflushing arm 46 discharges into a middle guide 74 located centrally to the longitudinal axis 22 of the filter housing 4; said middle guide on its bottom has two diametrically opposite outlets 76 in order to always be able to ensure a fluid-carrying connection to a connecting line 78 which, viewed in the direction of looking at FIGS. 1 and 2, discharges to the right into a conventional valve means 48.

As a result of the valve means 48, which since it is conventional is only partially shown, its actuation upon release enables a sudden, pulsed cleaning of the respective filter element 2 which is to be backflushed within the entire device. As soon as a cleaning process has been completed, the valve means 48 closes, and the backflushing arm 46 is moved by means of the geared motor 72 and the indicated gear mechanism to under another free filter element 2 which is to be backflushed. The previously backflushed filter element 2 is then available in turn via its lower free inlet opening for filtration of contaminated fluid. The filter device 1 is preferably executed in a stand construction 79, and an electronic control, adjustment, and input means 80 is used for overall operation of the device with the incorporation of the valve means 48 and of the geared motor 72.

1. A filter device having a plurality of filter elements (2) which can be accommodated in a filter housing (4) having a filter inlet (6) for a fluid (8) to be filtered and a filter outlet (10) for the filtered fluid (12), flow through the filter elements (2) being possible in both directions for filtration or backflushing, characterized in that between at least some of the filter elements (2) and the filter outlet (10), in each instance one further filter element, especially in the form of a fine filter element (14), is arranged in the regions of the flow path of the fluid which is prefiltered by the respective filter element (2) assigned to the further filter element (14).

2. The filter device according to claim 1, characterized in that the fine filter elements (14) are made tubular and radially encompass the filter elements (2) while maintaining a definable distance.

3. The filter device according to claim 1, characterized in that the fine filter elements (14) have a greater axial extension (a) than the filter elements (12), preferably have at least three times the length of the filter elements (2).

4. The filter device according to claim 1, characterized in that the filter elements (2) have a conical or cylindrical shape and the fine filter elements (14) have a cylindrical or conical shape.

5. The filter device according to claim 1, characterized in that the fine filter elements (14) are formed as wound depth filters from paper, textiles, or plastic materials.

6. The filter device according to claim 1, characterized in that the fine filter elements (14) are formed from a fibrous mat which is not woven and not wound.

7. The filter device according to claim 1, characterized in that the fine filter elements (14) consisting of a pleated material are supported on a support element.

8. The filter device according to claim 1, characterized in that the fine filter elements (14) on their side facing the fluid (8) which is to be filtered have a larger pore size or mesh width than on their clean side (18).

9. The filter device according to claim 1, characterized in that the filter elements (2) and the fine filter elements (14) surrounding them are arranged at distances to one another along at least one arc or a closed imaginary circle within the filter housing (4).

10. The filter device according to claim 1, characterized in that the filter elements (2) are made as cylindrical wedge wire screen filter elements (20), preferably constructed from high-grade steel materials.

11. The filter device according to claim 1, characterized in that the filter elements (2) and fine filter elements (14) with parallel longitudinal axis to the longitudinal axis (22) of the filter housing (4) are held in coaxial arrangement in the filter housing (4).

12. The filter device according to claim 1, characterized in that the filter housing (4) has a cylindrical shape and on the end side is provided with a screw-on bottom (24) and a cover (26), the cover (26) accommodating a holding means (28) located with a distance (b) thereto for the fine filter elements (14).

13. The filter device according to claim 12, characterized in that the holding means (28) is a disk (30) which can be inserted into the filter housing (4) and which has openings (32), adjacent to each opening (32) a fine filter element (14) being secured radially and/or axially detachably on the disk (30), and that the respective opening (32) for fluid passage of a partial fluid amount (TF) overlaps at least partially the free fluid-carrying face of the fine filter element (14).

14. The filter device according to claim 12, characterized in that the disk (30) is held by a retaining arm (34) which is supported at least radially on the filter housing (4) via retaining projections (37).

15. The filter device according to claim 14, characterized in that the retaining arm (34) can be secured by a type of quarter-turn fastener (36).

16. The filter device according to claim 15, characterized in that the disk (30) has a tightening screw (38) for axial clamping of the quarter-turn fastener (36) and as part thereof.

17. The filter device according to claim 1, characterized in that the filter elements (2) have an inner filter cavity (56) which on the end side at least partially overlaps an inlet opening (54) in the bottom (24), via which opening fouled fluid (8) can be routed both in filtration and also in backflushing.

18. The filter device according to claim 17, characterized in that for purposes of backflushing there is a backflushing means (44) with at least one backflushing arm (46) which can be connected to the respectively assignable inlet opening (52) of the filter element (2) which is to be cleaned and which arm can be actuated by a geared motor (72).

19. A filter element arrangement for installation in a filter device according to claim 1, characterized in that a fine filter element (14) is connected to a filter element (2) as a manageable unit.
